(19) United States
(12) Patent Application Publication
(10) Pub. No.: US 2008/0002621 A1
(43) Pub. Date: Jan. 3, 2008

(54) Reliable multicast techniques for wireless links

(76) Inventors: Boris Ginzburg, Haifa (IL); Max Fudim, Kiriat Bialik (IL)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/479,634

(22) Filed: Jun. 29, 2006

(51) Int. Cl. H04Q 7/00

(52) U.S. Cl. 370/331

(57) ABSTRACT

Two techniques that may be used to improve multicast traffic reliability, which may include a multicast frame retransmission policy and/or a multicast frame retransmission mode.

### TECHNICAL FIELD

Embodiments of the invention relate to wireless communications protocols. More particularly, embodiments of the invention relate to techniques for providing reliable multicast transmissions for IEEE 802.11 wireless communications protocols.

### BACKGROUND

Multicast generally refers to a transmission where a single source node transmits data to multiple destination nodes. As wireless network access becomes increasingly popular the desire for reliable wireless multicast techniques will increase. However, current IEEE 802.11 wireless network standards (e.g., IEEE 802.11b, IEEE 802.11g) define multicast protocols that are not reliable. This may result in less than satisfactory wireless multicast performance.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. IEEE 802.11b and IEEE 802.11g work in conjunction with IEEE 802.11a-1999 entitled “Wireless LAN Medium Access Control (MAC) and Physical Layer (PHY) specifications, High-Speed Physical Layer in the 5 GHz Band,” approved in 1999 and reaffirmed 12 Jun. 2003.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates a block diagram of one embodiment of a wireless local area network.

FIG. 2 is a flow diagram of one embodiment of a subscription handshake in which a mobile node may subscribe to a reliable multicast transmission.

FIG. 3 is a timing diagram of one embodiment of a multicast subscription handshake that may activate access point mechanisms utilizing IEEE 802.11 wireless communication protocols.

FIG. 4 is a flow diagram of one embodiment of a strategy for reliable transmission of multicast packets over a wireless network communications protocol.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein are techniques that may improve the reliability of downlink multicast traffic. In general, when a multicast frame is transmitted over an IEEE 802.11 wireless link, no acknowledge (ACK) message is sent and no Request To Send/Clear To Send (RTS/CTS) mechanism is applied. Thus, there may be no Media Access Control (MAC) level recovery mechanism for multicast frame transmission. As a result the probability of multicast frames loss may be higher than the probability of frame loss for unicast and/or wired traffic, which may reduce multicast traffic reliability.

Described herein are two techniques that may be used to improve multicast traffic reliability, which may include a multicast frame retransmission policy and/or a multicast frame retransmission mode. A user (e.g., an system administer) may define the retransmission policy and the retransmission mode for each multicast group identified by a Level 2 (MAC, or data link layer) multicast address or by Level 3 (Network layer) tags, for example, Differentiated Services Code Point (DSCP) tags. Policy definitions may be stored on and/or applied by a wireless access point.

In one embodiment, two policy types may be supported for multicast frame retransmission by the access point—(1) all frame retransmission, or (2) selective frame retransmission. In one embodiment, when the all frame retransmission policy is enabled, all multicast frames associated with a corresponding multicast address are automatically retransmitted according to the selected retransmission mode, which is described in greater detail below.

In one embodiment, when the selective frame retransmission policy is enabled, a portion of the multicast frames associated with a corresponding multicast address are retransmitted according to the selected retransmission mode. Selection of candidates from retransmission may be accomplished, for example, according to the frame type that is identified by the network tags. The wireless access point may perform mapping of various frame types to corresponding tags.

In one embodiment, two modes may be supported for multicast frame retransmission by the access point—(1) send as unicast, or (2) multiple times as multicast. Transmission of multicast frames as unicast frames may be based on subscription of a mobile station to a multicast address, which is described in greater detail below. The wireless access point may utilize an adaptive strategy for transmitting multicast frames as unicast frames based on, for example, the number of mobile nodes subscribed to a multicast address.

Transmission of multicast frames multiple times may result in the multicast frames to be retransmitted (as determined by the retransmission policy) a pre-selected number of times. For example, a policy for selective retransmission of frames that include a MPEG video stream (having I-frames, P-frames and B-frames) could be defined by differentiation of I-frames (e.g., four retransmissions) from P- and B-frames (e.g., two retransmissions), which may improve the quality of MPEG video streams transmitted on an IEEE 802.11 wireless link by increasing reliability of multicast frames.

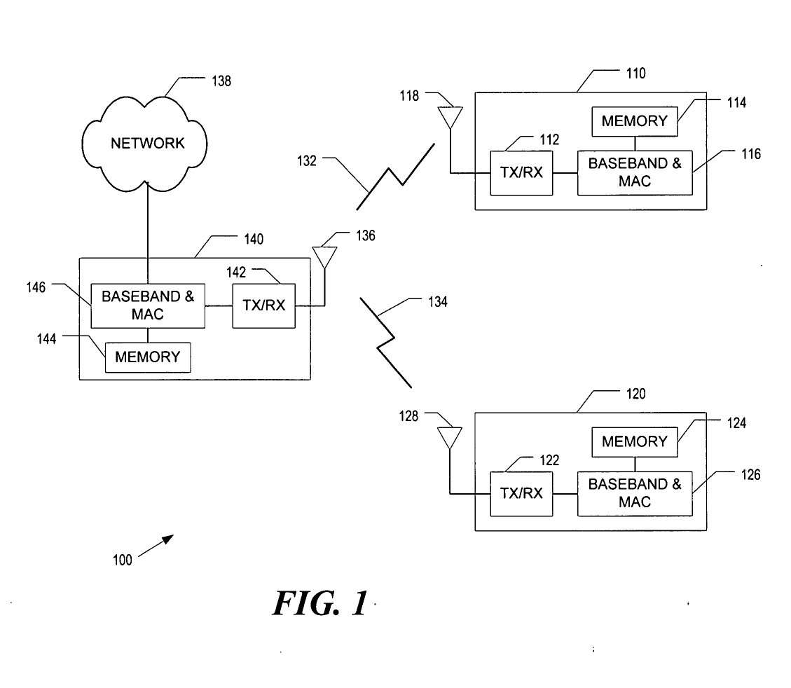

FIG. 1 illustrates a block diagram of one embodiment of a wireless local area network. In wireless local area network (WLAN) system 100 shown in FIG. 1, a first device 110 may include wireless transceiver 112 to couple to antenna 118 and to baseband processor 116. Baseband processor 116 in one embodiment may include a single processor, or alternatively may include a baseband processor and an applications processor, although the scope of the invention is not limited in this respect.

Baseband processor 116 may couple to memory 114 which may include volatile memory such as DRAM, non-volatile memory such as flash memory, or alternatively may include other types of storage such as a hard disk drive, although the scope of the invention is not limited in this respect. Some portion or all of memory 114 may be included on the same integrated circuit as baseband processor 116, or alternatively some portion or all of memory 114 may be disposed on an integrated circuit or other medium, for example a hard disk drive, that is external to the integrated circuit of baseband processor 116, although the scope of the invention is not limited in this respect. Likewise, second device 120 may include transceiver 122, memory 124, baseband processor 126, and antenna 128. Access point 140 may include a transceiver 142, memory 144, baseband processor 146 and antenna 136.

First device 110 and second device 120 may communicate with access point 140 via wireless communication links 132 and 134, respectively. Access point 140 may include at least one antenna 136. Alternatively, access point 140, and optionally first device 110 and second device 120, may include two or more antennas to provide a diversity antenna arrangement, to provide spatial division multiple access (SDMA), or to provide a multiple input, multiple output (MIMO) system, or the like, although the scope of the invention is not limited in this respect.

Access point 140 may couple with network 138 so that first device 110 and second device 120 may communicate with network 138, including devices coupled to network 138, by communicating with access point 140 via wireless communication links 132 and 134. Network 138 may include a public network such as a telephone network or the Internet, or alternatively network 138 may include a private network such as an intranet, or a combination of a public and a private network, although the scope of the invention is not limited in this respect.

Communication between user first device 110 and second device 120 and access point 140 may be implemented in accordance with one or more wireless standards including, for example, one or more wireless networking standards such as an IEEE 802.11 standard. In one embodiment, WLAN system 100 includes multiple devices capable of communicating with first device 110 and access point 140. WLAN system 100 may include multiple other devices capable of communicating with second device 120 and access point 140.

In accordance with one embodiment, access to the medium is controlled by a media access control (MAC) sublayer of the Data Link Layer as described in a wireless standard. In particular, MAC operations control which devices, access point 140, first device 110 and/or second device 120, can initiate communications over the medium.

In one embodiment, first device 110, second device 120, and access point 140 may be arranged to communicate over an identical or similar frequency band, for example near 5 GHz, wherein the transceivers 112, 122, and 142 of first device 110, second device 120, and access point 140, respectively, are arranged to operate on a compatible physical layer, although the scope of the invention is not limited in this respect.

As described in greater detail below, access point 140 may transmit packets to first device 110 and second device 120 (as well as other devices not illustrated in FIG. 1) as part of a reliable multicast transmission. In one embodiment, access point 140 may implement a retransmission policy and/or utilize a retransmission mode to improve the reliability of multicast transmissions. The retransmission policy and/or the retransmission mode may be provided to access point 140 by, for example, a remote device via network 138. The retransmission policy and/or the retransmission mode may be generated (or otherwise determined) by, for example, a network administrator.

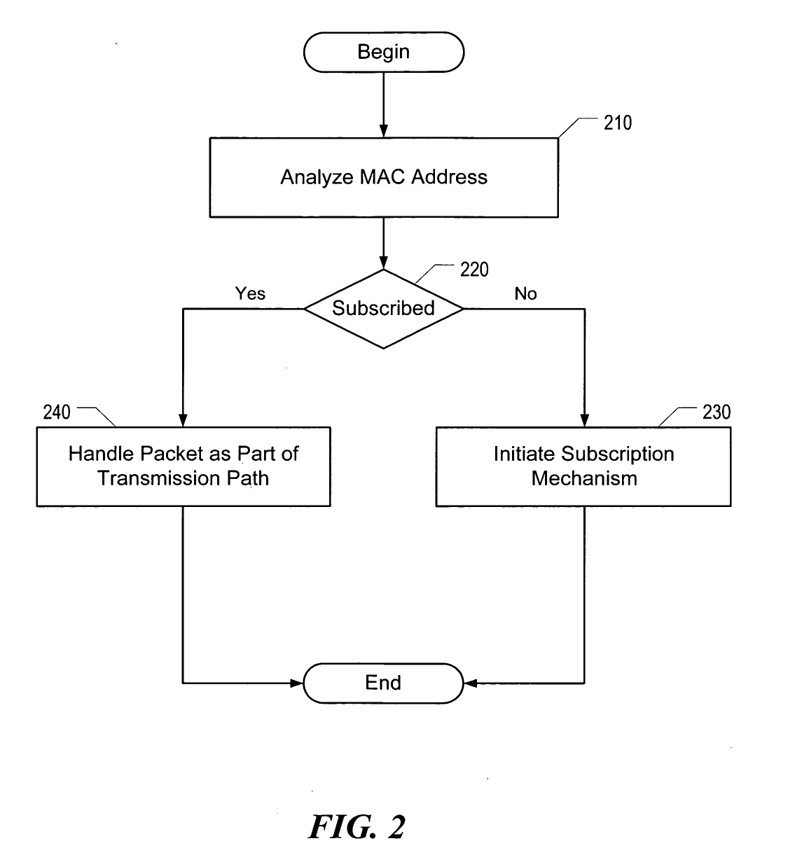

FIG. 2 is a flow diagram of one embodiment of a subscription handshake in which a mobile node may subscribe to a reliable multicast transmission. In one embodiment, the subscription handshake of FIG. 2 may be integrated into Transmit and Receive flows of IEEE 802.11-compliant network interfaces.

In one embodiment, an access point may receive a packet from a mobile node. The access point may analyze the MAC address of the packet, 210. If the mobile node is subscribed to the MAC address, 220, multicast packets may be handled as part of the transmission (transmit and receive) path, 240. If the mobile node is not subscribed to the MAC address, 220, the access point may initiate a subscription mechanism, 230. Any subscription technique may be used.

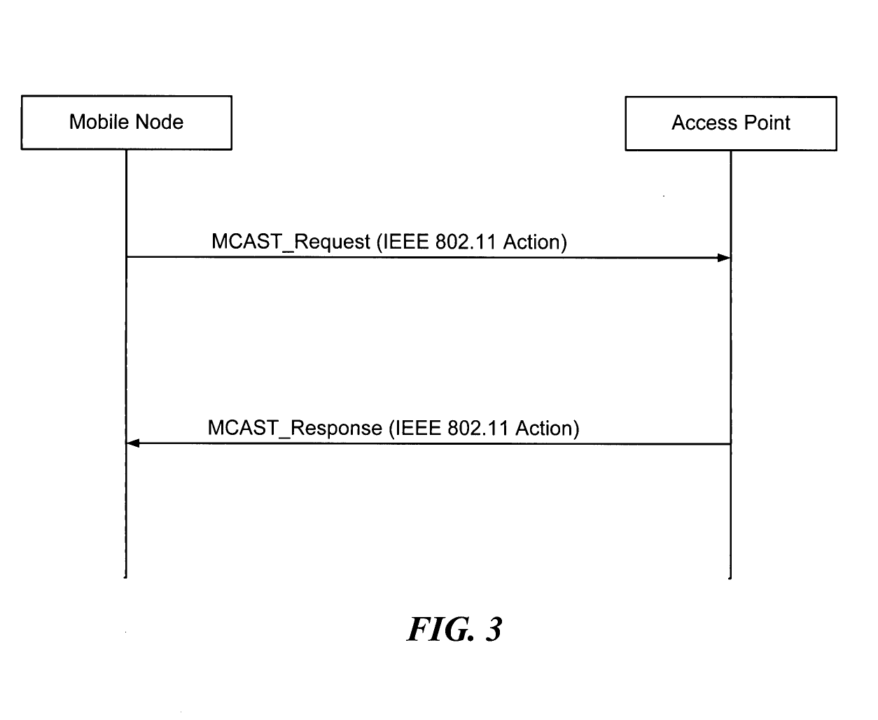

FIG. 3 is a timing diagram of one embodiment of a multicast subscription handshake that may activate access point mechanisms utilizing IEEE 802.11 wireless communication protocols. In one embodiment, the mobile node may utilize a two-way multicast frame subscription handshake.

In one embodiment, to initiate the multicast subscription handshake a mobile node may transmit a MCAST_Request message (which is an IEEE 802.11 defined action) to the appropriate access point. In response, the access point may transmit a MCAST_Response message (which is also an IEEE 802.11 defined action) back to the mobile node. The request and response messages may be utilized to convey information between the access point and the mobile node to support the functionality of the reliable wireless multicast transmissions as described herein.

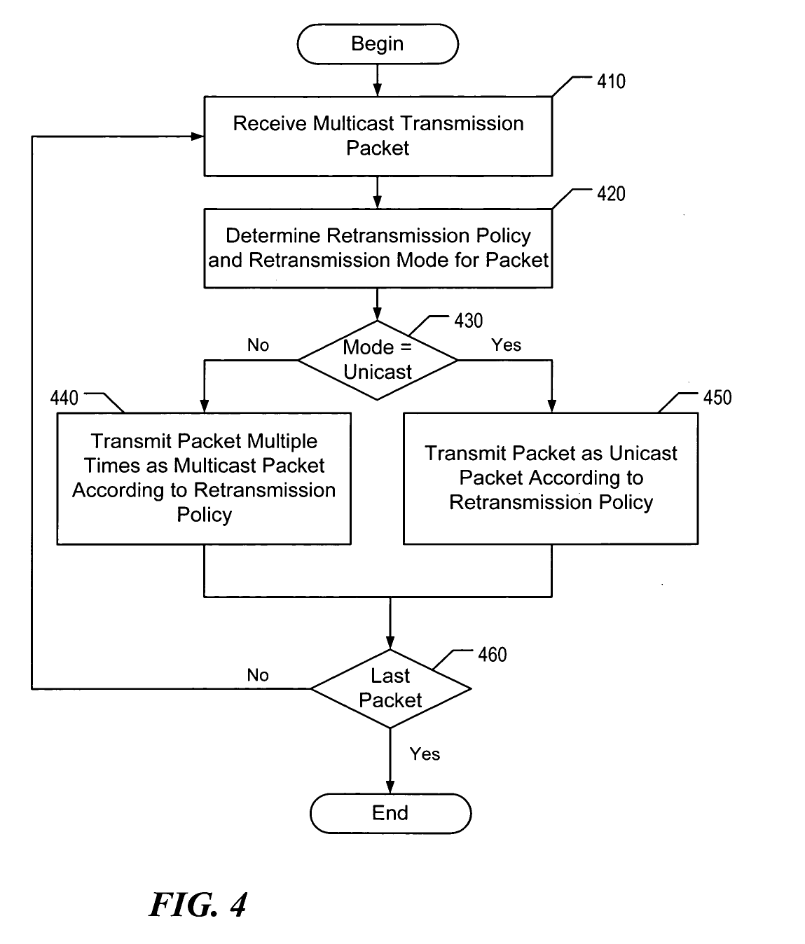

FIG. 4 is a flow diagram of one embodiment of a strategy for reliable transmission of multicast packets over a wireless network communications protocol. While the example of FIG. 4 is presented in a specific ordering or sequence, this is for illustration purposes only. In various embodiments, the ordering of processing may be different than the example of FIG. 4.

As described below, there are four combinations from which to select in transmitting packets over the wireless network. The combinations include 1) transmit the packet as unicast traffic (mode) for all packets (policy); 2) transmit the packet as unicast traffic (mode) for selected packets (policy); 3) transmit the packet as multicast traffic multiple times (mode) for all packets (policy); and 4) transmit the packet as multicast traffic multiple times (mode) for selected packets (policy).

In one embodiment, an access point may receive a multicast packet to be transmitted via a wireless network protocol (e.g., IEEE 802.11), 410. The packet may be received in any manner known in the art via wired or wireless transmission protocols. The access point may determine the retransmission policy and the retransmission mode for the packet, 420. In one embodiment, the retransmission policy and/or the retransmission mode may be user-supplied from, for example, a network administrator. The retransmission policy and/or the retransmission mode by me defined in any manner, for example, based on parameters associated with the packet to be transmitted.

In one embodiment, the retransmission policy and/or the retransmission mode may be adaptive based on, for example, the number of subscribed mobile nodes, the type of packet to be transmitted, contents of the packet to be transmitted, etc. The retransmission policy and/or the retransmission mode may be communicated, for example, using the network functionality as described above.

The access point may determine whether the retransmission mode for the packet is unicast transmission, 430. If the packet is to be transmitted as a unicast packet, 430, the packet may be transmitted as a unicast packet to each of the subscribed nodes according to the retransmission policy, 440. That is, all packets may be transmitted as unicast traffic or selected packets may be transmitted as unicast traffic, depending on the selected retransmission policy.

If the packet is not to be transmitted as a unicast packet, 430, the packet may be transmitted as many times as indicated by the retransmission policy as a multicast packet to each of the subscribed nodes according to the retransmission policy, 450. That is, all packets may be transmitted as multicast traffic multiple times or selected packets may be transmitted as multicast traffic multiple times, depending on the selected retransmission policy. If the packet is not the last packet, 460, the process may be repeated for subsequent packets.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a packet of data to be transmitted to multiple subscribed target nodes; and
transmitting the packet to the target nodes multiple times based, at least in part, on a retransmission policy and a retransmission mode, wherein the retransmission policy indicates parameters of packets to be automatically retransmitted.

2. The method of claim 1 wherein the packet is transmitted to the target nodes according to a wireless network protocol.

3. The method of claim 2 wherein the wireless network protocol comprises an IEEE 802.11-compliant wireless protocol.

4. The method of claim 1 wherein the retransmission mode comprises packet transmission as a unicast packet or packet transmission as a multicast packet.

5. The method of claim 1 wherein the retransmission policy comprises transmitting a first packet having a first set of parameters a first number times and transmitting a second packet having a second set of parameters a second number of times.

6. The method of claim 5 wherein the first set of parameters comprises a first type of video frame data and the second set of parameters comprises a second type of video frame data.

7. The method of claim 1 wherein the transmission policy varies based, at least in part, on a number of target nodes.

8. The method of claim 1 wherein the retransmission policy is adaptable to vary for packets within a multicast session.

9. The method of claim 1 wherein the retransmission mode is adaptable to vary for packets within a multicast session.

10. An article of manufacture comprising a computer-readable medium having stored thereon instructions that, when executed, cause one or more processors to:
receive a packet of data to be transmitted to multiple subscribed target nodes; and
transmit the packet to the target nodes multiple times based, at least in part, on a retransmission policy and a retransmission mode, wherein the retransmission policy indicates parameters of packets to be automatically retransmitted.

11. The article of claim 10 wherein the packet is transmitted to the target nodes according to a wireless network protocol.

12. The article of claim 11 wherein the wireless network protocol comprises an IEEE 802.11-compliant wireless protocol.

13. The article of claim 10 wherein the retransmission mode comprises packet transmission as a unicast packet or packet transmission as a multicast packet.

14. The article of claim 10 wherein the retransmission policy comprises transmitting a first packet having a first set of parameters a first number times and transmitting a second packet having a second set of parameters a second number of times.

15. The article of claim 14 wherein the first set of parameters comprises a first type of video frame data and the second set of parameters comprises a second type of video frame data.

16. The article of claim 10 wherein the transmission policy varies based, at least in part, on a number of target nodes.

17. The article of claim 10 wherein the retransmission policy is adaptable to vary for packets within a multicast session.

18. The article of claim 10 wherein the retransmission mode is adaptable to vary for packets within a multicast session.

19. A wireless access point comprising:
receiving circuitry coupled to receive a packet of data to be transmitted to multiple target nodes communicatively coupled with the wireless access point;
a memory to store the packet;
wireless transmission circuitry to transmit data to multiple subscribed nodes; and
a processor coupled with the memory and the wireless transmission circuitry, the processor to cause the packet to be transmitted to the target nodes via the wireless transmission circuitry multiple times based, at least in part, on a retransmission policy and a retransmission mode, wherein the retransmission policy indicates parameters of packets to be automatically retransmitted.

20. The access point of claim 19 wherein the wireless transmission circuitry transmits data according to an IEEE 802.11-compliant wireless protocol.

21. The access point of claim 19 wherein the retransmission mode comprises packet transmission as a unicast packet or packet transmission as a multicast packet.

22. The access point of claim 19 wherein the retransmission policy comprises transmitting a first packet having a first set of parameters a first number times and transmitting a second packet having a second set of parameters a second number of times.

23. The access point of claim 22 wherein the first set of parameters comprises a first type of video frame data and the second set of parameters comprises a second type of video frame data.

24. The access point of claim 19 wherein the transmission policy varies based, at least in part, on a number of target nodes.

25. The access point of claim 19 wherein the retransmission policy is adaptable to vary for packets within a multicast session.

26. The access point of claim 19 wherein the retransmission mode is adaptable to vary for packets within a multicast session.

27. A network comprising:
a plurality of target nodes;
an access point configured to communicate with the plurality of target nodes according to a wireless network protocol, wherein the access point receives a packet of data to be transmitted to the plurality of target nodes and transmits the packet to the plurality of target nodes multiple times based, at least in part, on a retransmission policy and a retransmission mode, wherein the retransmission policy indicates parameters of packets to be automatically retransmitted.

28. The network of claim 27 wherein the wireless transmission circuitry transmits data according to an IEEE 802.11-compliant wireless protocol.

29. The network of claim 27 wherein the retransmission mode comprises packet transmission as a unicast packet or packet transmission as a multicast packet.

30. The network of claim 27 wherein the retransmission policy comprises transmitting a first packet having a first set of parameters a first number times and transmitting a second packet having a second set of parameters a second number of times.

31. The network of claim 30 wherein the first set of parameters comprises a first type of video frame data and the second set of parameters comprises a second type of video frame data.

32. The network of claim 27 wherein the transmission policy varies based, at least in part, on a number of target nodes.
